(19) United States
(12) Patent Application Publication
(10) Pub. No.: US 2005/0244548 A1
(43) Pub. Date: Nov. 3, 2005

(54) Food container for improving appetite

(76) Inventor: Dido Cheng, Taipei City (TW)

Correspondence Address: BIRCH STEWART KOLASCH & BIRCH, PO BOX 747, FALLS CHURCH, VA, 22040-0747, US

(21) Appl. No.: 10/834,875

(22) Filed: Apr. 30, 2004

(51) Int. Cl. A23B 4/00

(52) U.S. Cl. 426/112

(57) ABSTRACT

A food container is provided for improving appetite. The food container contains mainly an open top vessel, a partition wall and an aroma generator. The partition wall divides the open top vessel into a first compartment having a first opening for containing a food and a second compartment having a second opening. The aroma generator is contained in the second compartment. Thereby a user can smell an aroma generated by the aroma generator in the second compartment when having the food in the first compartment.

### TECHNICAL FIELD

This invention relates generally to a food container, in particular, to provide a food container for improving appetite.

### BACKGROUND OF THE INVENTION

When enjoying a food (solid or liquid), human not only use their tongues taste the flavor of the food but also smell the food. Tongue can differentiate sour, sweet, bitter, salty only four basic kinds of flavor. As to barbecue, fruit or other flavors, human sense them through nasal cavity. Sometimes the aromas come directly to the nasal cavity and other times, the aromas come through oral cavity to nasal cavity. The nasal cavity collects the smell and tells brain what the flavor it is.

Study indicates most delicious foods contain high fat and calories and are harmful to human health if over consumed. In view of this, people try to change their eating habits. The popularity of healthy food (natural organic food and diet food) is a good example showing people are aware of the danger of high calories. However, usually those healthy foods are light flavored and people cannot really enjoy consuming the foods. Boiled water or mineral water is good for human being but they are light flavored or have no flavor at all. Therefore people prefer soft drinks with heavy flavor such as sweet or sour. Those soft drinks contain sugars and artificial addictives, which are against human health.

In addition to the deliciousness of food itself, there are some other ways improving appetite. For example, delicate and fanciful glasses, cups, glasses, and dishes with special shapes or designs can visually improve an eater's appetite. However, the effect is limited and different people in different places and time have very different feelings toward the appearances and colors of the food containers. Therefore a food container that can effectively improve an eater's appetite when eating food without worry about deterioration of health is needed.

### SUMMARY OF INVENTION

Therefore, the primary objective of the present invention is to provide a food container that can improve appetite.

The present invention, briefly summarized, in one embodiment discloses a food container contains mainly an open top vessel, a partition wall and an aroma generator. The partition wall divides the open top vessel into a first compartment having a first opening for containing a food and a second compartment having a second opening. The aroma generator is contained in the second compartment. Thereby a user can smell an aroma generated by the aroma generator in the second compartment when having the food in the first compartment. In another embodiment, the present invention provides a food container containing an open top vessel having a side wall, an open top box, an aroma generator, and a second cover. The open top box is attached to the side wall. The open top box has a top aligned with a top of the open top vessel. The aroma generator is contained in the open top box. The second cover detachably covers the open top box. The second cover has plural third pores whereby an aroma generated from the aroma generator can emit out of the open top box.

### BRIEF DESCRIPTION OF DRAWINGS

The invention will be more clearly understood after referring to the following detailed description read in conjunction with the drawings wherein:

FIG. 1 is an exploded view of the first embodiment of the present invention;

FIG. 2 is a perspective view of the first embodiment;

FIG. 3 is a cross sectional view of the first embodiment when in use;

FIG. 4 is an exploded view of the second embodiment;

FIG. 5 is an exploded view of the third embodiment; and

FIG. 6 is an exploded view of the fourth embodiment.

### DETAILED DESCRIPTION OF PREFERRED EMBODIMENTS

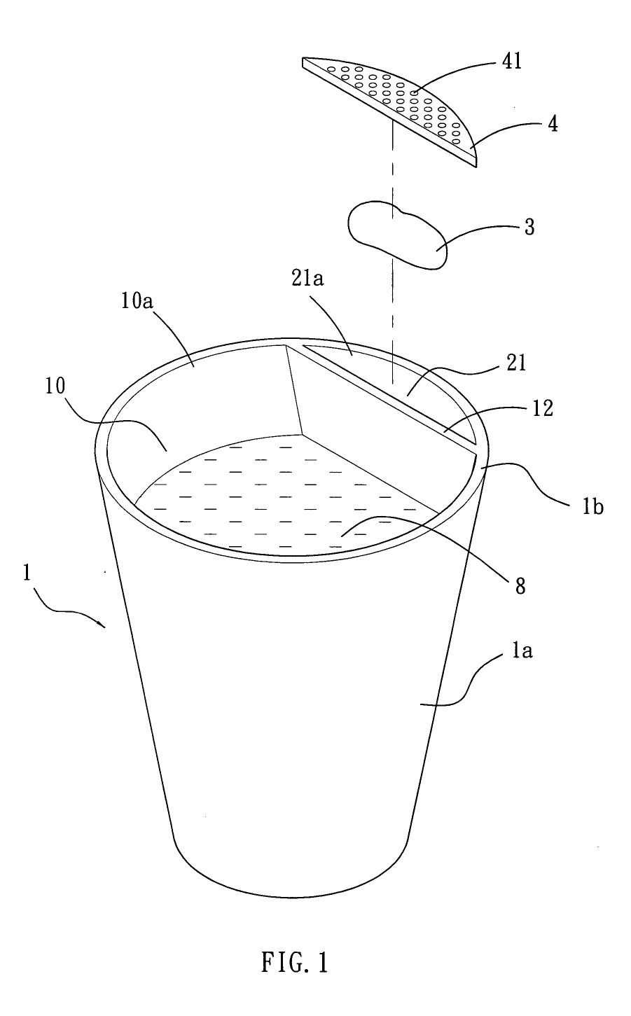

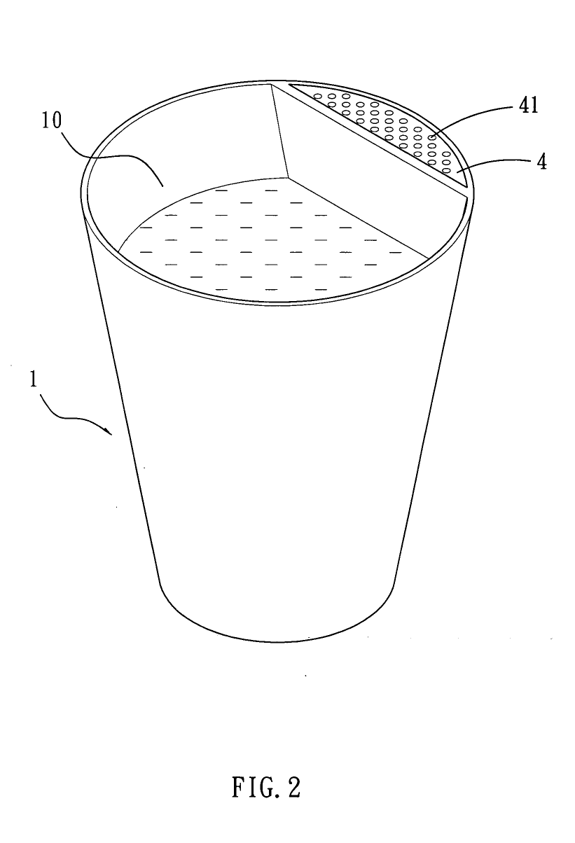

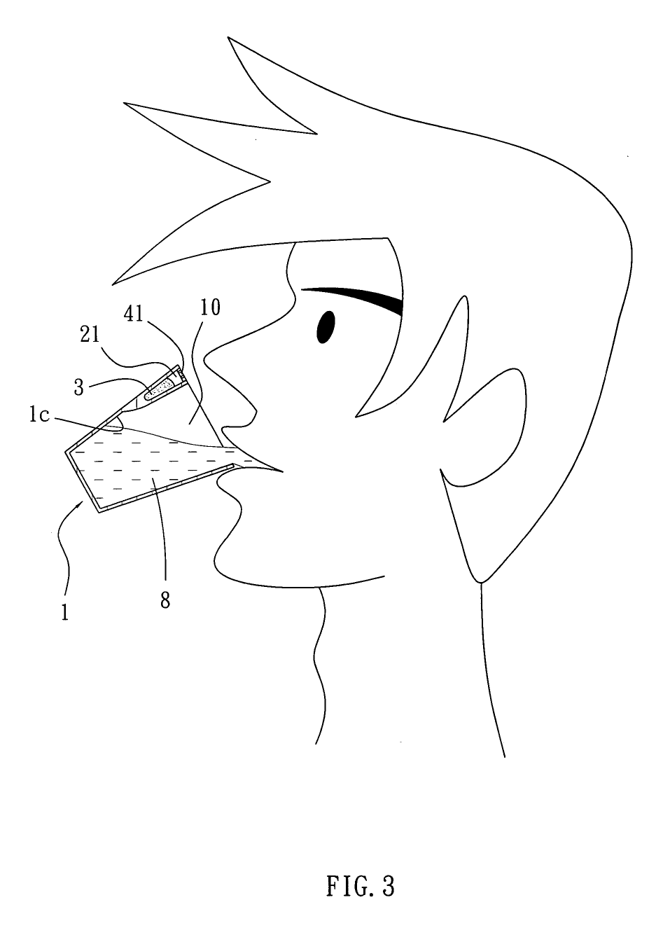

The present invention provides a food container for improving appetite. With reference to FIG. 1, FIG. 2 and FIG. 3 the first embodiment of present invention contains an open top vessel 1, a partition wall 12 and an aroma generator 3. The partition wall 12 divides the open top vessel 1 into a first compartment 10 having a first opening 10a for containing a food and a second compartment 21 having a second opening 21a. In this embodiment, the food is water 8 (a liquid food.) The aroma generator 3 is contained in the second compartment 21. The aroma generator 3 generates lemon aroma. The first opening 10a of the first compartment 10 is larger than the second opening 21a of the second compartment 21 and the partition wall 12 extends from an inner side 1c of a side wall 1a of the open top vessel 1 to a latitude aligned with a top 1b of the open top vessel 1. A first cover 4 detachably covers the second opening 21a for preventing the aroma generator 3 falling out of the second compartment 21. A user can exchange aroma generator 3 with different flavor such as whisky flavor by just lifting the first cover 4. The first cover 4 has plural first pores 41 whereby an aroma generated from the aroma generator 3 can emit out of the second compartment. With reference to FIG. 3, when a user puts his mouth on the first opening 10a for drinking the water 8, his nose is in a position close to the plural first pores 41. Thereby a user can smell a lemon aroma generated by the aroma generator 3 in the second compartment 21. If the aroma generator 3 is of a whisky flavor, the user feels like drinking real whisky. The lemon aroma contacts the nasal cavity of the user and the nasal cavity delivers a message to the brain. Since the user drinks the water 8 simultaneously smell the lemon aroma, he feels as if the water 8 has lemon flavor.

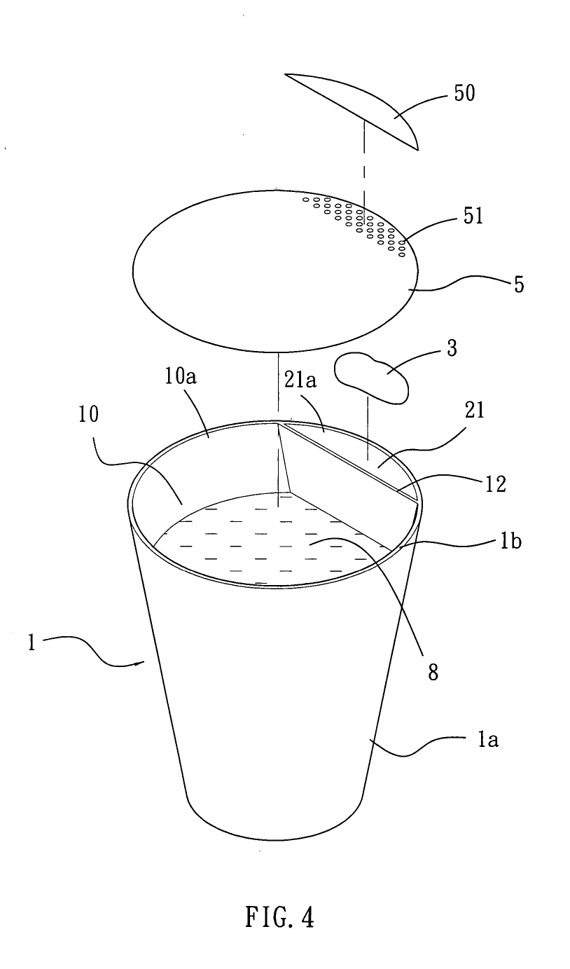

Referring to FIG. 4, the second embodiment contains an open top vessel 1, a partition wall 12 and an aroma generator 3. The partition wall 12 divides the open top vessel 1 into a first compartment 10 having a first opening 10a for containing a food and a second compartment 21 having a second opening 21a. In this embodiment, the food is water 8 (a liquid food.) The aroma generator 3 is contained in the second compartment 21. The aroma generator 3 generates lemon aroma. The first opening 10a of the first compartment 10 is larger than the second opening 21a of the second compartment 21 and the partition wall 12 extends from an inner side (not shown) of a side wall 1a of the open top vessel 1 to a latitude aligned with a top 1b of the open top vessel 1. A first seal 5 seals the first opening 10a of the first compartment 10 and the second opening 21a of the second compartment 21. The first seal 5 has plural second pores 51 above the second compartment 21 whereby an aroma generated from the aroma generator 3 can emit out of the second compartment 21. A sealing film 50 seals the plural second pores 51 preventing the aroma evaporates gradually. When using the second embodiment, a user punches through the first seal 5 to reach the water 8 and take off the sealing film 50 to smell the aroma.

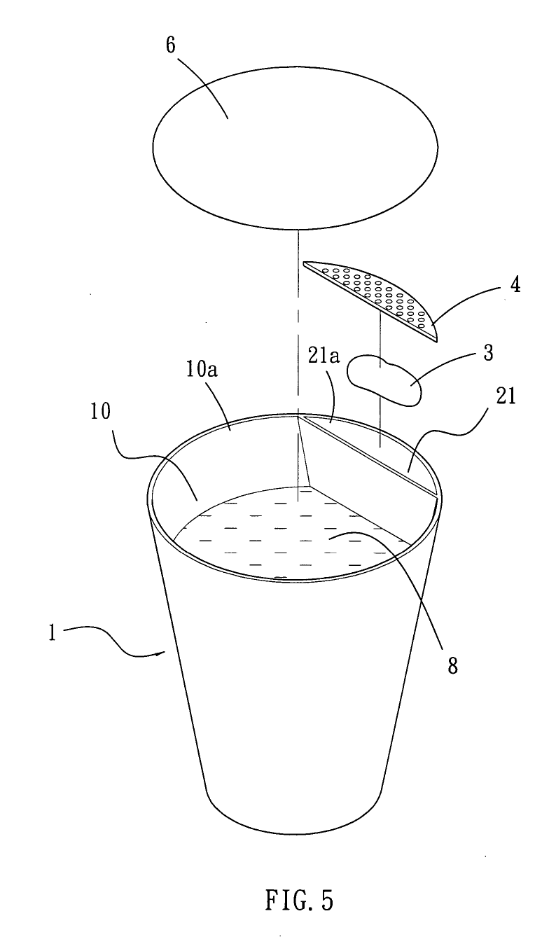

With reference to FIG. 5, the third embodiment contains all the elements and structures of the first embodiment. The third embodiment further contains a second seal 6 sealing the first opening 10a of the first compartment 10 and the first cover 4 for preventing the aroma evaporates gradually and the water 8 leaking out of the first compartment 10.

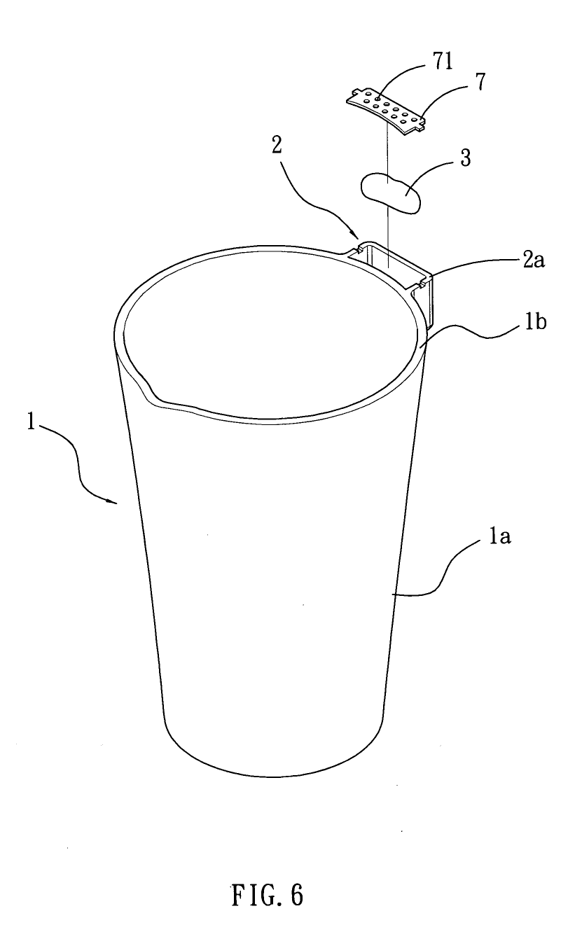

With reference to FIG. 6, the fourth embodiment contains an open top vessel 1 having a side wall 1a, an open top box 2, and aroma generator 3. The open top box 2 is attached to the side wall 1a. The open top box 2 has a top 2a aligned with a top 1b of the open top vessel 1. The aroma generator 3 is contained in the open top box 2. A second cover 7 detachably covers the open top box 2. The second cover 7 has plural third pores 71 whereby an aroma generated from the aroma generator 3 can emit out of the open top box 2.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extent indicated by the broad general meaning of the terms in which the appended claims are expressed.

1. A food container for improving appetite comprising:
an open top vessel;
a partition wall dividing said open top vessel into a first compartment having a first opening for containing a food and a second compartment having a second opening; and
an aroma generator contained in said second compartment;
whereby a user can smell an aroma generated by said aroma generator in said second compartment when having said food in said first compartment.

2. The food container of claim 1, wherein said first opening of said first compartment is larger than said second opening of said second compartment and said partition wall extends from an inner side of a side wall of said open top vessel to a latitude aligned with a top of said open top vessel.

3. The food container of claim 1 further comprising a first cover detachably covering said second opening, said first cover having plural first pores whereby an aroma generated from said aroma generator can emit out of said second compartment.

4. The food container of claim 1 further comprising a first seal sealing said first opening of said first compartment and said second opening of said second compartment, said first seal having plural second pores above said second compartment whereby an aroma generated from said aroma generator can emit out of said second compartment.

5. The food container of claim 3 further comprising a second seal sealing said first opening of said first compartment and said first cover.

6. The food container of claim 4 further comprising a sealing film sealing said plural second pores.

7. A food container for improving appetite comprising:
an open top vessel having a side wall;
an open top box attached to said side wall, said open top box having a top aligned with a top of said open top vessel;
an aroma generator contained in said open top box; and
a second cover detachably covering said open top box, said second cover having plural third pores whereby an aroma generated from said aroma generator can emit out of said open top box.
